(19) United States
(12) Patent Application Publication
(10) Pub. No.: US 2022/0198290 A1
(43) Pub. Date: Jun. 23, 2022

(54) Randomization-Based Network of Domain Specific Rule Bases

(71) Applicant: United States of America as represented by the Secretary of the Navy, San Diego, CA (US)

(72) Inventor: Stuart H. Rubin, San Diego, CA (US)

(21) Appl. No.: 17/125,062

(22) Filed: Dec. 17, 2020

(51) Int. Cl. G06N 5/02; G06F 16/242

(52) U.S. Cl. CPC G06N 5/025; G06F 16/243; G06N 5/022

(57) ABSTRACT

An artificial intelligence system and a method for its operation include rule bases established to maintain rules for respective knowledge domains. A network links the rule bases together. A first rule in every rule base references a second rule in another rule base via the network, and the network at least interconnects every first and second rule bases for which the first rule in the first rule base references the second rule in the second rule base. The artificial intelligence system is adapted to invoke a third one of the rules of a particular one of the rule bases in response to an input from a user of the artificial intelligence system, and this begins a chain invoking the rules of the rule bases via the network. The chain includes the first rule in one of the rule bases invoking the second rule in another one of the rule bases.

### FEDERALLY-SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, Calif., 92152; voice (619) 553-5118; ssc_pac_t2@navy.mil. Reference Navy Case Number 111794.

### BACKGROUND OF THE INVENTION

Artificial intelligence systems include neural networks and rule bases. Both neural networks and rule bases scale poorly. To address complex problems, neural networks require larger training sets and longer training times, until training becomes intractable upon scaling beyond an attainable limit. Rule bases require many rules to address complex problems. Intensive labor from specialized knowledge engineers is needed to capture knowledge in the rules and this considerable human effort limits the achievable size of a rule base.

There is a general need for artificial intelligence systems that transcend scaling limits to address arbitrarily complex problems.

### SUMMARY

An artificial intelligence system and a method for its operation include rule bases established to maintain rules for respective knowledge domains. A network links the rule bases together. A first rule in every one of the rule bases references a second rule in another one of the rule bases via the network, and the network at least interconnects every first and second ones of the rule bases for which the first rule in the first rule base references the second rule in the second rule base. The artificial intelligence system is adapted to invoke a third one of the rules of a particular one of the rule bases in response to an input from a user of the artificial intelligence system, and this begins a chain invoking the rules of the rule bases via the network. The chain includes the first rule in one of the rule bases invoking the second rule in another one of the rule bases.

### BRIEF DESCRIPTION OF THE DRAWINGS

Throughout the several views, like elements are referenced using like references. The elements in the figures are not drawn to scale and some dimensions are exaggerated for clarity.

FIG. 1A and FIG. 1B are conceptual diagrams of evolving randomization in artificial intelligence systems in accordance with various embodiments of the invention.

FIG. 2 is a block diagram of an artificial intelligence system in accordance with various embodiments of the invention.

FIG. 3 is a data flow diagram of an artificial intelligence system in accordance with various embodiments of the invention.

FIG. 4 is a flow diagram of a process for operating an artificial intelligence system in accordance with various embodiments of the invention.

### DETAILED DESCRIPTION OF EMBODIMENTS

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

Again, artificial intelligence systems are needed that transcend scaling limits to address arbitrarily complex problems. Scaling to ever-larger systems entails drawbacks because knowledge becomes increasingly interdependent. However, the quantity of information contained on a per bit basis can increase without bound with scaling to larger and larger systems. This counter-intuitive principle is explained in the reference herein incorporated: S. H. Rubin, “On Randomization and Discovery,” Information Sciences, 177 (1) 170-191, 2007.

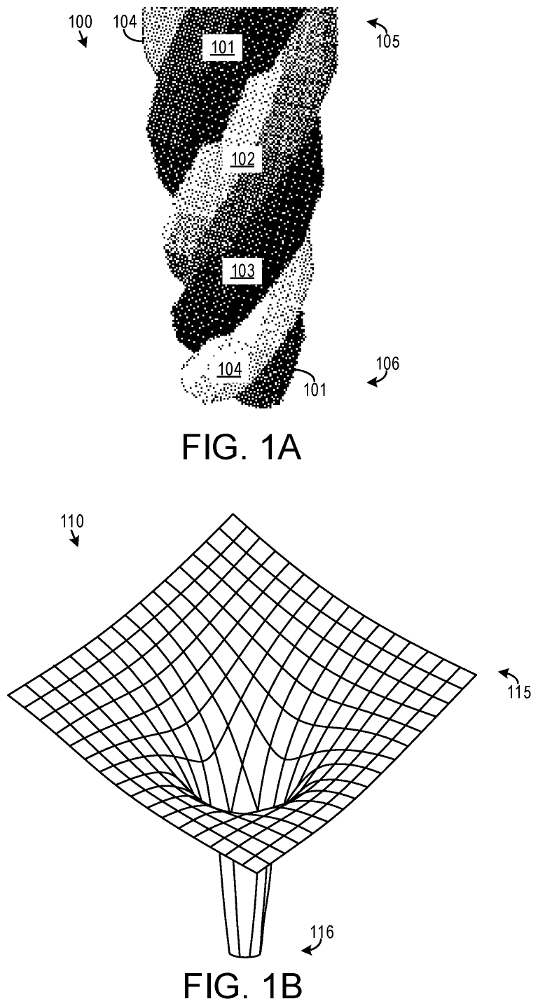

FIG. 1A is a conceptual diagram 100 of evolving randomization in an artificial intelligence system in accordance with various embodiments of the invention. FIG. 1A shows four randomization transformations 101, 102, 103, and 104 that transform each other during evolution from an initial configuration at the top 105 of the diagram 100 to a minimum configuration at the bottom 106 of the diagram 100. The width at the top 105 represents a combination of the storage space and computation time initially required to implement all of the randomization transformations 101, 102, 103, and 104.

During evolution, the randomization transformations 101, 102, 103, and 104 transform each other. In one example, randomization transformation 101 is compiler optimizations that optimize executable code for all of the randomization transformations 101, 102, 103, and 104. In this example, randomization transformation 102 is a data compression algorithm that compresses the data structures of all of the randomization transformations 101, 102, 103, and 104. In this example, randomization transformations 103 and 104 are similar transformations that reduce the space/time required to specify the randomization transformations 101, 102, 103, and 104.

At the bottom 106 of the diagram 100, the same knowledge is represented as at the top 105 of the diagram 100, but the width is reduced to indicate this knowledge requires less space/time to specify the randomization transformations 101, 102, 103, and 104 in full. When the randomization transformations 101, 102, 103, and 104 are a fully effective set for randomization, the width at the bottom 106 of the diagram 100 represents the minimum amount of space/time required to specify the randomization transformations 101, 102, 103, and 104. Thus, the randomization transformations 101, 102, 103, and 104 evolve each other to become fully randomized at the bottom 106 of the diagram 100.

Humans learn by analogy from past experiences. For example, identical twins, each new to the game of chess, but one of whom knows checkers, will learn chess at different rates because some of the checkers knowledge, but not all, maps onto the game of chess. The parts that so map are said to be symmetric; whereas, the remaining parts are said to be random. Almost all real-world knowledge falls into a mixture of the two categorizations. The symmetric part between first and second knowledge domains requires no additional space/time. The random part does require additional space/time, and randomization reduces the required additional space/time to the minimum amount of additional space/time,

FIG. 1B is a conceptual diagram 110 of evolving randomization in an artificial intelligence system in accordance with various embodiments of the invention. FIG. 1B shows evolution similar to FIG. 1A, but the evolution of FIG. 1B also includes the evolution of learning during operation of the artificial intelligence system. Thus, FIG. 1B not only includes randomization transformations similar to those of FIG. 1A, but also includes learning processes acquiring knowledge during operation of the artificial intelligence system. Thus, the amount of knowledge increases during evolution from the top 115 to the bottom 116 of the diagram 110. However, randomization reduces the amount of space/time required to specify this increasing amount of knowledge. The conceptual diagram 110 is akin to a black hole accumulating an ever increasing mass of knowledge, with an event horizon at the bottom 116 of the diagram 110 akin to the minimum space/time required to specify the accumulated knowledge at the current scaling of the artificial intelligence system.

Motivated by the insight that knowledge density is unbounded with scaling to larger systems, the inventor sought to discover artificial intelligence systems that transcend scaling limits to address arbitrarily complex problems.

Neural networks, including those with hidden nodes for implementing deep learning, suffer from drawbacks besides training becoming intractable for complex problems. Neural networks cannot generalize or extend knowledge because neural networks are incapable of modus ponens. The learning of neural networks is not conceptually based and is not readily explainable. Because learning in neural networks is based on gradient descent, neural networks are not context sensitive in the conceptual sense.

The human brain is an exemplar of an intelligent system that solves complex problems. The human brain preforms modus ponens, i.e. linking together a chain of causes and effects, and human learning is conceptually based, explainable, and context sensitive. Because these are all deficiencies of neural networks, but capabilities of rule bases, rather than attempting to overcome these deficiencies of neural networks, the inventor turned instead to discovering advancements that overcome the limits of existing rule bases.

A first discovery is that although a universally applicable rule base would require too much labor from specialized knowledge engineers to capture the universal knowledge in the rules, specialized rule bases for narrow problem domains are reasonably achievable. Multiple such specialized rule bases can be linked together in a network, and more complex problems than the individual narrow problem domains are mastered when the rules in the rule base for each narrow domain invoke rules in the rule bases of the other narrow domains.

For example, a weather rule base and a sailing rule base are networked together so that the sailing rule base can predict an initial sailing route between two points after asking the weather rule base to predict the general wind speed and direction in the area, with refinement to the fastest sailing route between the two points using the instantaneous wind speed and direction predicted at each intermediate point along the fastest sailing route. Thus, the network of narrow rule bases becomes self-referential with loops developing among the narrow rule bases when the rules in each rule base invoke the rules in a remote rule base.

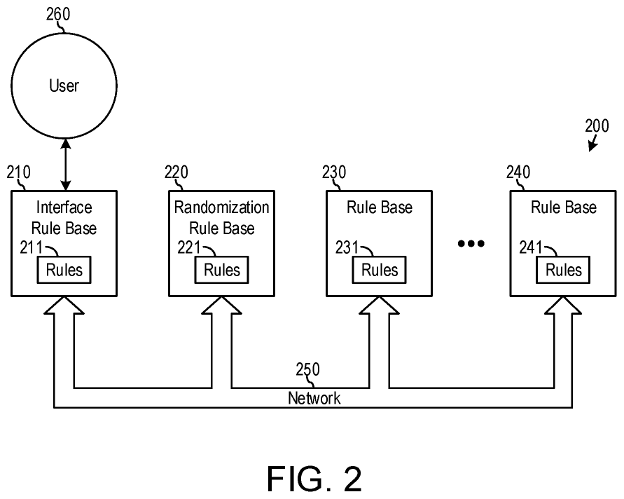

FIG. 2 is a block diagram of an artificial intelligence system 200 in accordance with various embodiments of the invention. The artificial intelligence system 200 includes rule bases 210, 220, and 230 through 240 that maintain rules 211, 221, and 231 through 241 for respective knowledge domains. Typically, the knowledge domains of the rule bases 210, 220, and 230 through 240 are different knowledge domains. A network 250 interconnects the rule bases 210, 220, and 230 through 240 in a fully connected network. Via the network 250, at least one of the rules 211, 221, and 231 through 241 in every one of the rule bases 210, 220, and 230 through 240 references a respective one of the rules 211, 221, and 231 through 241 in another one of the rule bases 210, 220, and 230 through 240. For example, a rule of rules 211 of rule base 210 references a rule of rules 221 of rule base 220.

During operation, the artificial intelligence system 200 invokes some of the rules 211, 221, and 231 through 241. For example, the artificial intelligence system 200 invokes one of rules 211 of rule base 210 in response to an input from a user 260 of the artificial intelligence system 200. Often, this begins a chain invoking certain rules 211, 221, and 231 through 241 of the rule bases 210, 220, and 230 through 240 via the network 250. For example, the chain includes a rule of rules 211 of rule base 210 invoking a rule of rules 221 of rule base 220.

A second discovery is that given a network 250 of specialized rule bases 210, 220, and 230 through 240, a user 260 can interact with the artificial intelligence system 200 via one of the specialized rule bases that is the interface rule base 210. The interface rule base 210 includes rules 211 for the knowledge domain of an expert system for interfacing between the user 260 and the artificial intelligence system 200. The interface rule base 210 receives input from the user 260 and delivers output to the user 260 in a natural language. The rules 211 of the interface rule base 210 specify how to translate from a natural language input from the user 260 to an internal encoding of the rules 211, 221, and 231 through 241 in the network 250 of the rule bases 210, 220, and 230 through 240, and specify how to translate from the internal encoding to a natural language output to the user 260.

Example natural language inputs and outputs include a query from user 260 requesting a solution to a problem, a request from the interface rule base 210 for the user 260 to provide situational information related to the problem, a response from user 260 answering the request to provide the situational information, a proposed action or actions for solving the problem that includes an audit trail explaining those of the rules 211, 221, and 231 through 241 of the rule bases 210, 220, and 230 through 240 invoked to arrive at each proposed action, and a confirmation from user 260 validating a proposed action for solving the problem.

A third discovery is that given a network 250 of specialized rule bases 210, 220, and 230 through 240, the needed skillfulness of the knowledge engineer further lessens when one of the specialized rule bases assists with the entry of rules into the artificial intelligence system 200. The specialized rule base for rule entry is either part of the interface rule base 210, or a separate rule-entry rule base that cooperates closely with the interface rule base 210. Although the rules 211, 221, and 231 through 241 for the narrow problem domain of each of the individual rule bases 210, 220, and 230 through 240 can be entered in a natural language that directly translates into the internal encoding of the rules 211, 221, and 231 through 241, the needed skillfulness of the knowledge engineer further lessens when the rule-entry rule base includes applicative rules for automatically creating the appropriate rules from a natural language specification of applicative and transformative situational sets and action sequences.

A fourth discovery is that such a network 250 of specialized rule bases 210, 220, and 230 through 240 fosters expansion of knowledge through randomization. In one example, the rule bases 230 and 240 are initialized with custom rules 231 and 241 generated from individual training instances input from user 260 via interface rule base 210 for the respective knowledge domains of the rule bases 230 and 240. Randomization combines the initial narrow rules 231 and 241 to create broader rules 231 and 241 that reduce complexity and increase knowledge density. Randomization reduces redundancy and increases knowledge density, with knowledge becoming increasingly compact in space and time as shown in FIG. 1B discussed above.

For example, rule base 230 is an expert system for animal behavior containing the rules 231, which are initialized to include the action rule instances “eagles fly” and “robins fly,” and rule base 240 is an expert system for biological taxonomy of plants and animals containing the rules 241, which are initialized to include the situational rule instances “eagles are birds” and “robins are birds.” The biological taxonomy of plants and animals might be maintained in a database, and the rule base 240 includes rules 241 for generating structured query language (SQL) references to the database. Randomization combines these rules from rule bases 230 and 240 into a new rule, “birds fly,” which new rule is added to the rule base 230 for animal behavior. Thus, new rules are hierarchically learned. Later, during operation of the artificial intelligence system 200, an invocation of the new rule might be validated by a user, or the user might modify the new rule to state, “birds fly unless they are ostriches or penguins.”

A fifth discovery is that given a network 250 of specialized rule bases 210, 220, and 230 through 240, the specialized rule bases can include a randomization rule base 220 containing rules 221 for guiding randomization. The randomization rule base 220 includes rules 221 for the respective knowledge domain of an expert system for randomizing the rules 211, and 231 through 241 of the rule bases 210 and 230 through 240 besides the randomization rule base 220. The artificial intelligence system 200 is self-referential because the randomization rule base 220 includes transformation rules 221 for transforming the rules 211 and 231 through 241 of the rule bases 210 and 230 through 240. This self-referential randomization gives the artificial intelligence system 200 the capability to learn how to learn.

A sixth optional discovery is that the rules 211, 221, and 231 through 241 of the rule bases 210, 220, and 230 through 240 do not need to be extensively searched to find exact or closest matches when an associative memory stores the rules 211, 221, and 231 through 241. A close match without an exact match can indicate a missing antecedent condition. Unlike a typical memory that is addressed with an address value that uniquely specifies a particular memory location, an associative memory is addressed with a data value that could address any memory location. In this optional embodiment, each of the rule bases 210, 220, and 230 through 240 includes an associative memory for storing rules 211, 221, and 231 through 241.

A seventh optional discovery is that rules 211, 221, and 231 through 241 having probabilities enable inexact of fuzzy operation of the artificial intelligence system 200. When two rules are invoked to solve a problem, the resulting probability is either a minimum or a product of the probabilities of the individual rules. A chain of invoked rules is squelched, i.e. discarded from further consideration, when a moving window over the chain has a combined probability less than a squelch limit.

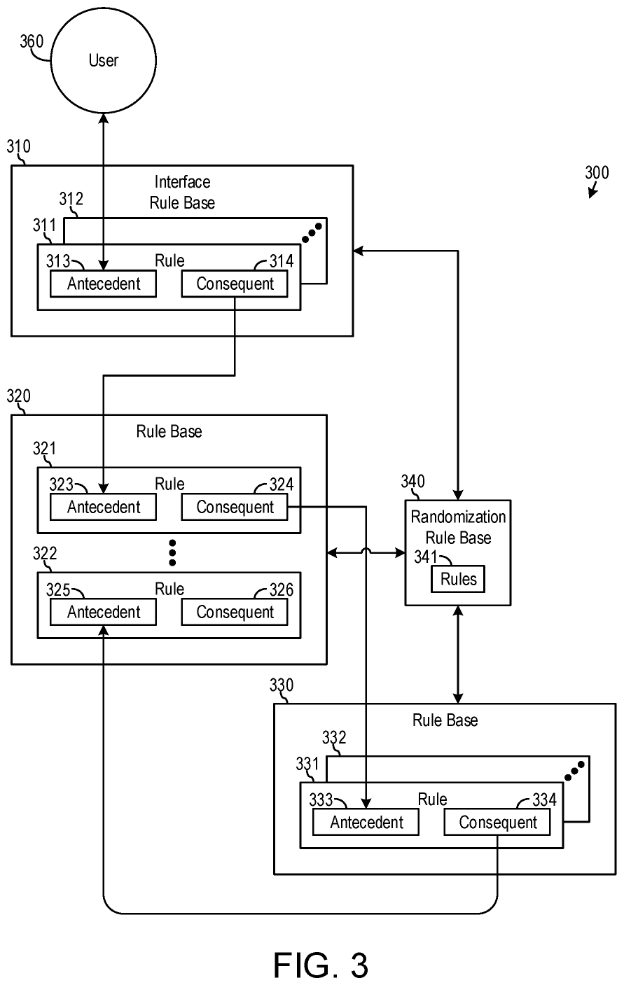

FIG. 3 is a data flow diagram of an artificial intelligence system 300 in accordance with various embodiments of the invention. The artificial intelligence system 300 establishes rule bases 310, 320, 330, and 340 for respective knowledge domains linked together in a network. In this example, interface rule base 310 includes rules 311 through 312 stored in an associative memory, rule base 320 includes rules 321 through 322 stored in an associative memory, rule base 330 includes rules 331 through 332 stored in an associative memory, and randomization rule base 340 includes rules 341 stored in an associative memory. Rule 311 of interface rule base 310 has an antecedent 313 and a consequent 314. Rule 321 of rule base 320 has an antecedent 323 and a consequent 324, and rule 322 of rule base 320 has an antecedent 325 and a consequent 326. Rule 331 of rule base 330 has an antecedent 333 and a consequent 334. In this example, the consequent 314 of rule 311 references the antecedent 323, of rule 321, the consequent 324, of rule 321, references the antecedent 333, of rule 331, and the consequent 334, of rule 331, references the antecedent 325 of rule 322.

One implementation of an associative memory has each memory location store both addressing data and associated data. When a data value is presented to the associative memory to retrieve the appropriate associated data, each memory location compares the presented data value with the addressing data stored in the memory location, and then any memory location with addressing data matching the presented data value outputs the associated data from the memory location as the appropriate associated data for the presented data value. Thus, when each rule, in a rule base, is stored in the associative memory with the antecedent stored in the addressing data of a respective memory location and the consequent stored in the associated data of this memory location, the consequent is immediately retrieved from the associative memory in a single time step upon presenting the antecedent as the data value presented to the associative memory.

In this example, rules 311 through 312 are stored in an associative memory for rule base 310. Rule 311 is stored in a memory location of the associative memory, with antecedent 313 stored in the addressing data of the memory location and consequent 314 stored in the associated data of the memory location. Similarly, each of the memory locations of an associative memory for rule base 320 stores an addressing data and an associated data, which is associated with the addressing data. The addressing data of the memory location for rule 321 stores antecedent 323 of rule 321 and the associated data of the memory location for rule 321 stores consequent 324 of rule 321. The memory location for rule 322 has the addressing data storing antecedent 325 and the associated data storing consequent 326. The associative memory for rule base 330 stores rule 331 in a memory location, with the addressing data storing antecedent 333 and the associated data storing consequent 334.

In this example, an input from the user 360 matches antecedent 313 stored in the addressing data of a memory location in the associative memory for interface rule base 310, which is addressing data associated with the associated data of the consequent 314. Thus, the input from the user 360 invokes rule 311 having a matching antecedent 313. Because rules 311 through 312 are stored in an associative memory of interface rule base 310, the input from user 360 is matched with antecedent 313 to invoke rule 311 and retrieve consequent 314 of rule 311 in a single time step, without iteratively searching the rules 311 through 312.

An associative memory should either preclude multiple matches, or preferably successively output the associated data from each of the matching memory locations. Preferably, the associative memory also tracks how long since each stored rule has been invoked. When there are multiple matches, they are output in an order from most specific to least specific rule, and then preferably from most to least-recently used. When a newly generated rule must overwrite an existing rule, the least-recently used rule is discarded. Knowledge usually expands despite such discarding of least-recently used rules because the new rule typically has a higher knowledge density than the discarded rule. Note that when randomization subsumes a set of rules into a new rule, some or all of the subsumed rules might be immediately discarded and their storage in the associative memory marked empty, so that no knowledge is lost upon adding the new rule into an empty memory location in the associative memory.

Because consequent 314 references rule base 320 and matches antecedent 323 of rule 321 in rule base 320, because rule 321 has consequent 324 that references rule base 330 and matches antecedent 333 of rule 331 in rule base 330, and because rule 331 has consequent 334 that references rule base 320 and matches antecedent 325 of rule 322 in rule base 320, the invocation of rule 311 in interface rule base 310 in response to an input from the user 360 begins a chain invoking rules 311, 321, 331, and 322.

The chain shown that invokes rules 311, 321, 331, and 322 forms a loop beginning with invoking rule 321 of specific rule base 320 and continuing through rule 331 of another rule base 330 until invoking rule 322 back in specific rule base 320. In this extreme example, every antecedent 323 of the entire loop and the consequent 326 of the entire loop are within specific rule base 320. The entire loop through rules 321, 331, and 322 can be subsumed into a new rule, which has an antecedent equaling antecedent 323 and a consequent equaling consequent 326, added to the specific rule base 320. This new rule extends knowledge obtained from a variety of rule bases 320 and 330, providing an example of increasing knowledge density with scaling. In the limit as discussed in FIG. 1B, this provides an information-theoretic black hole with unprecedented strategic value.

The artificial intelligence system 300 includes a randomization rule base 340 including the rules 341 for the respective knowledge domain of an expert system for randomizing the rules 311 through 312, 321 through 322, and 331 through 332 of all of the rule bases 310, 320, and 330 besides the randomization rule base 340. The rules 341 in the randomization rule base 340 specify how to combine those rules 321, 331, and 322 in the loop. When rules 341 for of the randomization rule base 340 are invoked, a new rule is generated that combines of those rules 321, 331, and 322 in the loop, and the new rule is added to the specific rule base 320.

For example, the user 360 requests a solution to a problem, and the artificial intelligence system 300 responds with a proposed action for solving the problem, the proposed action including an audit trail explaining the rules 311, 321, 331, and 322 of the chain invoked to arrive at the proposed action, or each of a set of proposed actions. When the user 360 confirms a proposed action is valid, the interface rule base 310 forwards the audit trail to the randomization rule base 340, which extracts the loop through rules 321, 331, and 322 within the chain, and combines these rules 321, 331, and 322 into a new rule added to the rule base 320.

A loop in a chain is not required for randomization by the randomization rule base 340. In a more typical example of randomization, when a chain of invoked rules requires antecedents from remote rule bases with a consequent at a particular rule base, the entire chain can be subsumed into a new rule that collects necessary antecedents from the remote rule bases. This new rule also expands knowledge with increased knowledge density.

The randomization rule base 340 is not limited to randomization in response to input from the user 360. In one embodiment, the randomization rule base 340 includes certain of rules 341 that continuously attempt to randomize the other rule bases 310, 320, and 330. In an extreme example of such background randomization, the randomization rule base 340 examines the rules 321 through 322 of rule base 320, and discovers that rule 321 has antecedent 323 specifying the condition A and B, rule 322 has antecedent 325 specifying the condition not A and B, and the same consequents 324 and 326 in rules 321 and 322. Through logical deduction, these two rules 321 and 322 are combined to yield a new rule having one antecedent B and consequent C. The new rule replaces rule 321, and rule 322 is marked empty to increase knowledge density without losing any knowledge.

Background randomization does not require such logical deduction from mutually exclusive antecedents. In a typical example of randomization, the randomization rule base 340 includes certain of rules 341 that, when invoked, randomly select a rule base (e.g. 320) besides the randomization rule base 340, randomly select a subset of the rules of the selected rule base (e.g. rules 321 and 322 out of rules 321 through 322 of selected rule base 320), and attempt to combine the selected subset of the rules of the select rule base. Although usually such randomly selected rules cannot be combined into a broader rule, knowledge is expanded with increased knowledge density whenever the randomly selected rules are successfully combined into a broader rule.

The randomization rule base 340 includes rules 341 specifying the background randomization through logical deduction and random selection. Random selection need not be completely random selection, for example, the rules 341 in the randomization rule base 340 guide the random selection of rules to combine, such as tending to select rules from a rule base with similar antecedents or similar consequents.

Thus, mere usage of the artificial intelligence system 300 of networked rule bases 310, 320, 330, and 340 to solve problems increases the knowledge stored in the artificial intelligence system 300 as new rules are generated continuously and in response to user input. Although the artificial intelligence system 300 has limited storage in practice, such that an existing rule must often be discarded when storing a new rule, because knowledge density increases without bound upon scaling past a critical size of the artificial intelligence system 300, mere usage of the artificial intelligence system 300 of networked rule bases 310, 320, 330, and 340 enables the artificial intelligence system 300 to store more and more knowledge without bound.

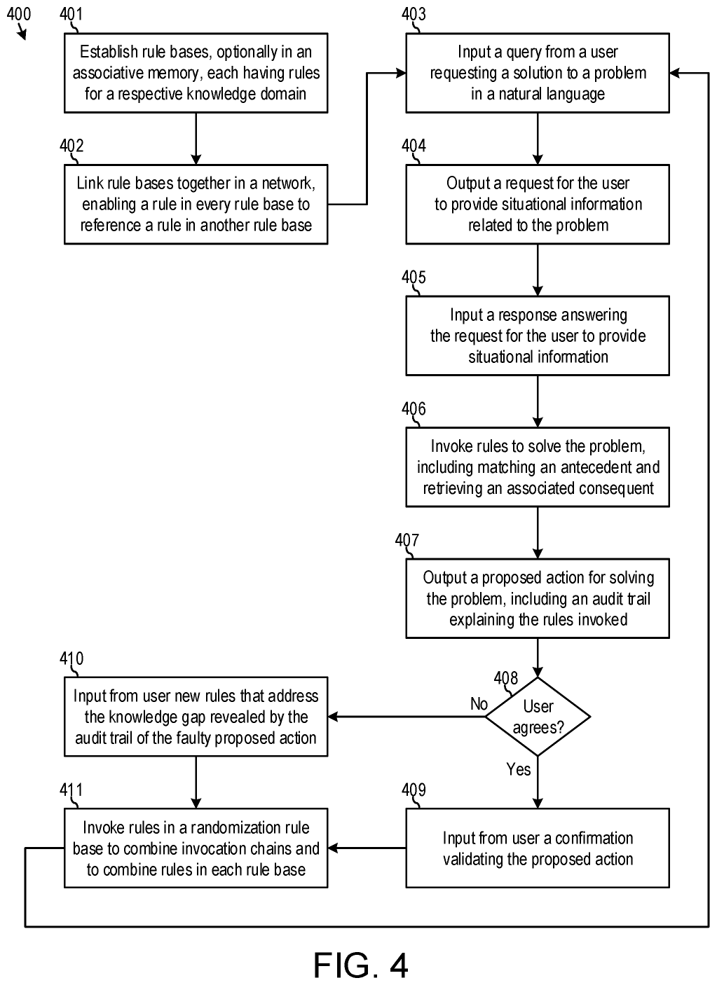

FIG. 4 is a flow diagram of a process 400 for operating an artificial intelligence system in accordance with various embodiments of the invention. The steps 401, 402, 410, and 411 in the left column describe building and transforming the artificial intelligence system, and the remaining steps in the right column describe using the artificial intelligence system to solve problems.

At step 401, rule bases are established, each including the rules for a respective knowledge domain. The rule bases optionally include associative memory for storing the rules. At step 402, the rule bases are linked together in a network to enable rules in each rule base to reference rules in another rule base.

At step 403, a query is input from a user requesting a solution to a problem. In one embodiment, the query in a natural language invokes rules of an interface rule base, and this begins a chain invoking the rules of the rule bases via the network. At step 404, the artificial intelligence system outputs a request for the user to provide situational information related to the problem. At step 405, a response is input from a user answering the request to provide situational information. At step 406, based upon the user's query and the user's answer providing situational information, rules of the rule bases of the artificial intelligence system are invoked to solve the problem. Generally, this includes invoking a chain of rules, with the invocation of each rule in the chain matching an antecedent of the rule and retrieving an associated consequent. At step 407, the artificial intelligence system outputs a proposed action for solving the problem. The proposed action includes an audit trail explaining the rules of the rule bases invoked to arrive at the proposed action.

At decision 408, the user determines whether the proposed action is valid. Often, this includes examining the audit trail explaining the rules invoked to arrive at the proposed action. If the user agrees with the proposed action, process 400 proceeds to step 409. At step 409, a confirmation is input validating the proposed action for solving the problem, and then process 400 proceeds to step 411.

If the user does not agree with the proposed action for solving the problem, process 400 proceeds from decision 408 to step 410 to address the knowledge gap revealed by the faulty proposed action. At step 410, after the user examines the audit trail explaining the rules invoked to arrive at the proposed action, the user adds new rules that address the knowledge gap. For a large knowledge gap, this might entail creation of a new rule base for a new knowledge domain. In one embodiment, these new rules are automatically generated from user input specifying applicative and transformative situational sets and action sequences that address the knowledge gap. Because the user specifies rules indirectly in natural language, less skill is required from a knowledge engineer, and this increases the incrementally achievable complexity of the artificial intelligence system.

At step 411, the transformational rules of a randomization rule base are invoked to combine rules of the other rule bases. The randomization rule base receives the audit trail of the proposed action, and, especially for a proposed action that is confirmed valid at step 409, the randomization rule base attempts to combine rules invoked to arrive at the proposed action. The randomization rule base also receives the new rules input at step 410, and attempts to combine the new rules with existing rules. In addition, the randomization rule base continuously preforms background randomization that randomly selects a rule base and a subset of the rules in the rule base and attempts to combine the rules in the subset into a new rule entered into the selected rule base.

From the above description of the Randomization-Based Network of Domain-Specific Rule Bases, it is manifest that various techniques may be used for implementing the concepts of artificial intelligence systems 200 and 300 and process 400 for operating an artificial intelligence system without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that systems 200 and 300 and process 400 are not limited to the particular embodiments described herein, but is capable of many embodiments without departing from the scope of the claims.

I claim:

1. A method for operating an artificial intelligence system, the method comprising:
establishing a plurality of rule bases, each including a plurality of rules for a respective one of a plurality of knowledge domains, wherein at least a first one of the rules in every one of the rule bases references a respective second one of the rules in another one of the rule bases;
linking the rule bases together in a network at least interconnecting every one of the rule bases and the another one of the rule bases for which the first rule in the one of the rule bases references the second rule in the another one of the rule bases; and
invoking a third one of the rules of a particular one of the rule bases in response to an input from a user of the artificial intelligence system, wherein the invoking of the third rule begins a chain invoking the rules of the rule bases via the network, the chain including the first rule in one of the rule bases invoking the second rule in another one of the rule bases.

2. The method of claim 1, wherein the knowledge domains of the rule bases are different knowledge domains.

3. The method of claim 1, wherein the rule bases include an interface rule base including the plurality of rules for the respective knowledge domain of an expert system for interfacing between the user and the artificial intelligence system.

4. The method of claim 3, wherein the invoking of the third rule includes invoking the third rule of the particular rule base, which is the interface rule base, in response to the input from the user that is a natural language input from the user.

5. The method of claim 4, wherein the natural language input from the user is selected from the group consisting of:
a query requesting a solution to a problem,
a response answering a request from the interface rule base for the user to provide situational information related to the problem, and
a confirmation validating a proposed action for solving the problem from the interface rule base.

6. The method of claim 3, wherein the rules of the interface rule base specify how to translate from the input that is a natural language input from the user to an internal encoding of the rules in the network of the rule bases, and specify how to translate from the internal encoding to a natural language output to the user.

7. The method of claim 6,
wherein the natural language input is selected from the group consisting of:
a query requesting a solution to a problem,
a response answering a request from the interface rule base for the user to provide situational information related to the problem, and
a confirmation validating a proposed action for solving the problem from the interface rule base, and
wherein the natural language output is selected from the group consisting of:
the request for the user to provide the situational information related to the problem and
the proposed action for solving the problem, the proposed action including an audit trail explaining the rules of the rule bases invoked to arrive at the proposed action.

8. The method of claim 1,
wherein when the chain invoking the rules of the rule bases forms a loop beginning with invoking one of the rules of a specific one of the rule bases and continuing invoking the rules of the rule bases until invoking of another one of the rules back in the specific rule base, and
the method further comprises adding a new rule to the specific rule base, the new rule combining those of the rules of the rule bases in the loop.

9. The method of claim 8,
wherein the rule bases include a randomization rule base including the plurality of rules for the respective knowledge domain of an expert system for randomizing the plurality of rules of every one of the rule bases besides the randomization rule base, with the rules in the randomization rule base specifying how to combine those rules in the loop, and
the method further comprises invoking the rules of the randomization rule base that:
generate the new rule from the combining of those rules in the loop; and
perform the adding of the new rule to the specific rule base.

10. The method of claim 1,
wherein the rule bases include a randomization rule base including the plurality of rules for the respective knowledge domain of an expert system for randomizing the plurality of rules of every one of the rule bases besides the randomization rule base, and
the method further comprises invoking the rules of the randomization rule base that:
randomly select a selected one of the rule bases besides the randomization rule base;
randomly select a subset of the rules of the selected rule base;
attempt to combine the subset of the rules of the selected rule base; and,
when the combining is successful to result in a combined rule, add the combined rule to the selected rule base.

11. The method of claim 1, wherein linking the rule bases together in the network includes linking every pairing of the rule bases together in the network that is a fully connected network, such that each of the rules in every one of the rule bases can reference each of the rules in any other one of the rule bases.

12. The method of claim 1, wherein:
the establishing of the rule bases includes storing the rules of each rule base in an associative memory for the rule base, the associative memory including a plurality of memory locations each having an addressing data and an associated data, which is associated with the addressing data; and
the storing of the rules in the associative memory for each rule base includes storing an antecedent of each rule of the rule base in the addressing data of a respective one of the memory locations and storing a consequent of the rule in the associated data of the respective one of the memory locations.

13. The method of claim 12, wherein the invoking of the third rule of the particular rule base in response to the input from the user includes:
matching the input from the user with the addressing data of a matching one of the memory locations that is storing the third rule in the associative memory for the particular rule base, and
retrieving the consequent of the third rule from the associated data of the matching one of the memory locations.

14. An artificial intelligence system comprising:
a plurality of rule bases, each maintaining a plurality of rules for a respective one of a plurality of knowledge domains; and
a network interconnecting the rule bases, wherein, via the network, at least a first one of the rules in every one of the rule bases references a respective second one of the rules in another one of the rule bases,
wherein the artificial intelligence system is adapted to invoke a third one of the rules of a particular one of the rule bases in response to an input from a user of the artificial intelligence system, beginning a chain invoking the rules of the rule bases via the network, the chain including the first rule in one of the rule bases invoking the second rule in another one of the rule bases.

15. The system of claim 14, wherein the third one of the rules of the particular one of the rule bases is the first rule in the one of the rule bases beginning the chain.

16. The system of claim 14, wherein the rule bases include a randomization rule base including the plurality of rules for the respective knowledge domain of an expert system for randomizing the plurality of rules of every one of the rule bases besides the randomization rule base.

17. The system of claim 16, wherein:
the rule bases include an interface rule base including the plurality of rules for the respective knowledge domain of an expert system for interfacing between the user and the artificial intelligence system, and
the rules of the interface rule base specify how to translate from a natural language input from the user to an internal encoding of the rules in the network of the rule bases, and specify how to translate from the internal encoding to a natural language output to the user.

18. The system of claim 17, wherein each rule base of the rule bases includes an associative memory for storing the rules of the rule base, with each memory location of a plurality of memory locations of the associative memory storing an addressing data and an associated data associated with the addressing data, the addressing data of the memory location for storing an antecedent of one of the rules of the rule base and the associated data of the memory location for storing a consequent of the one of the rules.

19. The system of claim 14, wherein:
the rule bases include an interface rule base including the plurality of rules for the respective knowledge domain of an expert system for interfacing between the user and the artificial intelligence system, and
the rules of the interface rule base specify how to translate from a natural language input from the user to an internal encoding of the rules in the network of the rule bases, and specify how to translate from the internal encoding to a natural language output to the user.

20. The system of claim 19, wherein each rule base of the rule bases includes an associative memory for storing the rules of the rule base, with each memory location of a plurality of memory locations of the associative memory storing an addressing data and an associated data associated with the addressing data, the addressing data of the memory location for storing an antecedent of one of the rules of the rule base and the associated data of the memory location for storing a consequent of the one of the rules.
